(19) United States
(12) Patent Application Publication
(10) Pub. No.: US 2013/0188715 A1
(43) Pub. Date: Jul. 25, 2013

(54) DEVICE AND METHODS FOR MERGE LIST REORDERING IN VIDEO CODING

(71) Applicant: QUALCOMM Incorporated, San Diego, CA (US)

(72) Inventors: VADIM SEREGIN, San Diego, CA (US); Xianglin Wang, San Diego, CA (US); Jianle Chen, San Diego, CA (US); Marta Karczewicz, San Diego, CA (US)

(73) Assignee: QUALCOMM Incorporated, San Diego, CA (US)

(21) Appl. No.: 13/735,974

(22) Filed: Jan. 7, 2013

Related U.S. Application Data
(60) Provisional application No. 61/584,695, filed on Jan. 9, 2012.

(51) Int. Cl. H04N 7/26

(52) U.S. Cl. CPC H04N 19/00587
USPC 375/240.16

(57) ABSTRACT

A video coding device configured according to some aspects of this disclosure includes a memory configured to store an initial list of motion vector candidates and a temporal motion vector predictor (TMVP). The video coding device also includes a processor in communication with the memory. The processor is configured to obtain a merge candidate list size value (N) and identify motion vector candidates to include in a merge candidate list having a list size equal to the merge candidate list size value. The merge candidate list may be a merge motion vector (MV) candidate list or a motion vector predictor (MVP) candidate list (also known as an AMVP candidate list). The processor generates the merge candidate list such that the merge candidate list includes the TMVP, regardless of the list size.

### CROSS-REFERENCE TO RELATED APPLICATIONS

This application claims priority from U.S. Provisional No. 61/584,695, filed Jan. 9, 2012, which is incorporated by reference herein in its entirety.

### FIELD

This disclosure generally relates to techniques for encoding and decoding video information.

### BACKGROUND

Digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into blocks. Each block may be further partitioned. Blocks in an intra-coded (I) frame or slice are encoded using spatial prediction with respect to neighboring blocks. Blocks in an inter-coded (P or B) frame or slice may use spatial prediction with respect to neighboring blocks in the same frame or slice or temporal prediction with respect to other reference frames.

### SUMMARY

In general, this disclosure relates to video encoding and decoding devices and methods that ensuring that a temporal motion vector predictor (TMVP) is included in a merge motion vector (MV) candidate list (also called the merge candidate list). Currently, according to the High Efficiency Video Coding (“HEVC”) standard, a merge candidate list may include five candidates. If the signaled merge candidate list size N of the merge candidate list is smaller than 5, only the first N candidates are used in the merge/skip mode's merge candidate list and the rest of the candidates are disregarded or discarded. However, because under HEVC the TMVP is generally added as the last (e.g., fifth) entry to the merge candidate list, the TMVP is likely discarded when a signaled, merge candidate list size N of the merge candidate list is smaller than five. However, coding performance may be degraded if a TMVP is not included in the merge candidate list. Therefore, according to various techniques of the present disclosure, methods and devices are provided to assure that the TMVP is included in the merge candidate list. Indeed, in some cases, the TMVP is included in the merge candidate list regardless of the merge candidate list size value N.

A video coding device configured according to some aspects of this disclosure includes a memory configured to store an initial list of motion vector candidates and a temporal motion vector predictor (TMVP). The video coding device also includes a processor in communication with the memory. The processor is configured to obtain a merge candidate list size value (N), and identify motion vector candidates to include in a merge candidate list having a list size equal to the merge candidate list size value N. The merge candidate list may be a merge motion vector (MV) candidate list or a motion vector predictor (MVP) candidate list (also known as an AMVP candidate list). The processor generates the merge candidate list to include the TMVP, regardless of the list size.

A method of video encoding according to some aspects of this disclosure includes storing an initial list of motion vector candidates and a TMVP. The initial list may include spatial MV candidates and other types of candidates. The method also includes obtaining a merge candidate list size value (N) and identifying one or more motion vector candidates to include in a merge candidate list that has a list size equal to the merge candidate list size value (N). The merge candidate list may be a merge motion vector (MV) candidate list or a motion vector predictor (MVP) candidate list (also known as an AMVP candidate list). The method includes generating the merge candidate list to include the TMVP regardless of the list size.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a block diagram that illustrates an example video coding system.

FIG. 2 is a block diagram that illustrates an example configuration of a video encoder.

FIG. 3 is a block diagram that illustrates an example configuration of a video decoder.

FIG. 4 is a conceptual diagram that illustrates example merge candidates.

FIG. 5 is an illustrative example of a merge motion vector (MV) candidate list.

FIG. 6 is a flowchart that illustrates an example of reordering a merge list by inserting the TMVP at a position with an index smaller than the list size.

FIG. 7 is an illustrative example of an initial merge candidate list.

FIG. 8 is an illustrative example of an embodiment of a merge candidate list.

FIG. 9 is a flowchart that illustrates a process of reordering a merge candidate list only when the merge list size (N) is greater than a threshold value (t).

FIG. 10 is a flowchart that illustrates a process of reordering a merge candidate list by swapping the TMVP with a merge MV candidate.

FIG. 11 is an illustrative example of an initial merge candidate list.

FIG. 12 is an illustrative example of an embodiment of a merge candidate list.

FIG. 13 is a flowchart that illustrates an example of reordering the merge candidate lists by independently signaling the sizes of the merge lists associated with each prediction unit (“PU”) in a coding unit (“CU”).

FIG. 14 is a flowchart that illustrates an example of reordering the merge candidate lists by inter-dependently signaling the sizes of the merge candidate lists associated with each prediction unit (“PU”) in a coding unit (“CU”).

FIG. 15 is a flowchart that illustrates an example of including the TMVP in the merge candidate list.

### DETAILED DESCRIPTION

Some aspects of the techniques of this disclosure relate to including a Temporal Motion Vector Predictor (“TMVP”) in a merge candidate list to ensure good coding performance. For instance, a video coding device may include a memory configured to store an initial list of motion vector candidates and a TMVP, and a processor in communication with the memory. The processor may be configured to receive a merge candidate list size value (N), identify one or more motion vector candidates to include in a merge candidate list having a list size equal to N, and generate the merge candidate list to include the TMVP, regardless of the list size N. The merge candidate list may be a merge motion vector (MV) candidate list or a motion vector predictor (MVP) candidate list (also known as an AMVP candidate list).

In some embodiments, a spot in the merge candidate list may be reserved for the TMVP. Moreover, in some cases, the TMVP may also be swapped with a motion vector candidate to make sure it is included in the merge candidate list.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). A draft of the HEVC standard, referred to as “HEVC Working Draft 6” is downloadable from http://phenix.int-evry.fr/jct/doc_{—}end_user/documents/8_San%20Jose/wg11/JCTVC-H1003-v6.zip. The full citation for HEVC Working Draft 6 is document JCTVC-H1003, Bross et al., “High Efficiency Video Coding (HEVC) Text Specification Draft 6,” Joint Collaborative Team on Video Coding (JCT-VC) of ITU-T SG16 WP3 and ISO/IEC JTC1/SC29/WG11, 7th Meeting: Geneva, Switzerland, Nov. 21, 2011 to Nov. 30, 2011. Another, later draft of the HEVC standard is available from http://wg11.sc29.org/jct/doc_end_user/current_document.php?id=5885/JCTVC-I1003-v2, as of Jun. 7, 2012. Another, later draft of the HEVC standard, referred to as “HEVC Working Draft 7” is downloadable from http://phenix.it-sudparis.eu/jct/doc_end_user/documents/9_Geneva/wg11/JCTVC-I1003-v3.zip, as of Jun. 7, 2012. The full citation for the HEVC Working Draft 7 is document HCTVC-11003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012. Another, later draft of the HEVC standard, referred to as HEVC WD8 (working draft 8) is available from http://phenix.int-evry.fr/jct/doc_end_user/documents/10_Stockholm/wg11/JCTVC-J1003-v8.zip. Each of these references is incorporated by reference in its entirety.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different video filters and video coders that may be used with, e.g., different wireless technologies, system configurations, networks, and transmission protocols, some of which are illustrated by way of example in the figures and in the following description of the particular aspects. The detailed description and drawings are merely illustrative of the disclosure rather than limiting, the scope of the disclosure being defined by the appended claims and equivalents thereof.

### Video Coding System

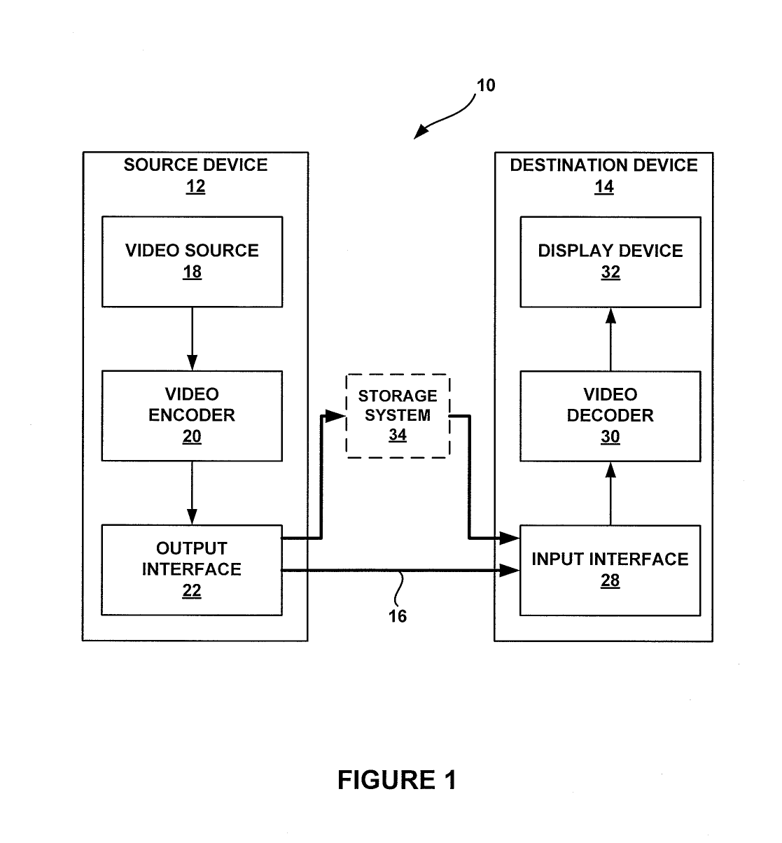

FIG. 1 is a block diagram that illustrates an example video coding system 10 that may utilize the techniques described in this disclosure. In this disclosure, the term “video coding” may refer to video encoding and video decoding. As shown in FIG. 1, video coding system 10 includes a source device 12 and a destination device 14. Source device 12 provides encoded video data to destination device 14. Destination device 14 may decode the encoded video data at a later time. Source device 12 and destination device 14 may comprise any of a wide range of devices, including desktop computers, notebook (i.e., laptop) computers, tablet computers, set-top boxes, mobile telephones, telephone handsets, “smart” pads, televisions, cameras, display devices, digital media players, video gaming consoles, video streaming devices, or types of computing devices capable of encoding and decoding video data.

Destination device 14 may receive the encoded video data via a communication channel 16. Communication channel 16 may comprise a medium or device capable of moving the encoded video data from source device 12 to destination device 14. In one example, communication channel 16 may comprise a communication medium that enables source device 12 to transmit encoded video data directly to destination device 14 in real-time. Source device 12 or another device may modulate the encoded video data according to a communication standard, such as a wireless communication protocol. The communication medium may comprise any wireless or wired communication medium, such as a radio frequency (RF) spectrum or one or more physical transmission lines. Communication channel 16 may form part of a packet-based network, such as a local area network, a wide-area network, or a global network such as the Internet. Communication channel 16 may include routers, switches, base stations, or any other equipment that may be useful to facilitate communication of the encoded video data from source device 12 to destination device 14.

In some examples, source device 12 and destination device 14 may be equipped for wireless communication. However, the techniques of this disclosure are not necessarily limited to wireless applications or settings. Rather, the techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, source device 12 and destination device 14 may be configured to support one-way or two-way video transmission to support applications such as video streaming, video playback, video broadcasting, and/or video telephony.

Furthermore, in some examples, source device 12 may output the encoded video data to a storage system 34. Similarly, destination device 14 may access encoded video data stored on storage system 34. In various examples, storage system 34 may include various distributed or locally accessed data storage media. Example types of data storage media include, but are not limited, to hard drives, Blu-ray discs, DVDs, CD-ROMs, solid state memory units, volatile or non-volatile memory, or other digital storage media suitable for storing encoded video data.

In some examples, storage system 34 may comprise a file server or another intermediate storage device that may hold the encoded video generated by source device 12. Destination device 14 may access stored video data from storage system 34 via streaming or download. The file server may be any type of server capable of storing encoded video data and transmitting that encoded video data to destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on a file server. The transmission of encoded video data from storage system 34 may be a streaming transmission, a download transmission, or a combination of both.

In the example of FIG. 1, source device 12 includes a video source 18, a video encoder 20 and an output interface 22. In some examples, output interface 22 may also include a modulator and/or a transmitter. Video source 18 provides video data to video encoder 20. In various examples, video source 18 may comprise various types of devices and/or systems for providing video data. For example, video source 18 may comprise a video capture device, such as a video camera. In another example, video source 18 may comprise a video archive that contains previously captured video. In yet another example, video source 18 may comprise a video feed interface that receives video from a video content provider. In yet another example, video source 18 may comprise a computer graphics system for generating computer graphics data.

As described in detail below, video encoder 20 may encode the video data provided by video source 18. In some examples, source device 12 may transmit the encoded video data directly to destination device 14 via output interface 22. Moreover, in some examples, storage system 34 may store the encoded video data for later access by destination device 14 or other devices.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage system 34) prior to being received and decoded by video decoder 30. Thus, the term “signaling” may generally refer to the communication of syntax or other data used to decode the compressed video data. Such communication may occur in real- or near-real-time. Alternately, such communication may occur over a span of time, such as might occur when storing syntax elements to a medium at the time of encoding, which then may be retrieved by a decoding device at any time after being stored to this medium.

In the example of FIG. 1, destination device 14 includes an input interface 28, a video decoder 30, and a display device 32. In some examples, input interface 28 may include a receiver and/or a modem. Input interface 28 of destination device 14 receives encoded video data from communication channel 16 and/or storage system 34. Video decoder 30 decodes the encoded video data received by input interface 28. Destination device 14 may render the decoded video data for display on display device 32.

Display device 32 may be integrated with or may be external to destination device 14. In some examples, destination device 14 may include an integrated display device and also be configured to interface with an external display device. In various examples, display device 32 may comprise various types of display devices. For example, display device 32 may comprise a liquid crystal display (LCD), a plasma display, an organic light emitting diode (OLED) display, or another type of display device.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. Example extensions to standards include the scalable video coding (SVC) and Multiview Video Coding (MVC) extensions to the H.264/AVC standard. Other examples of video compression standards include MPEG-2 and ITU-T H.263. The techniques of this disclosure are not limited to any particular coding standard.

As mentioned briefly above, video encoder 20 encodes video data. The video data may comprise one or more sequences of pictures. Each of the pictures is a still image. In some instances, a picture may be referred to as a “frame.” When video encoder 20 encodes the video data, video encoder 20 may generate a bitstream. The bitstream includes a sequence of bits that form a representation of coded pictures and associated data. A coded picture is a coded representation of a picture.

To generate the bitstream, video encoder 20 may perform an encoding operation for sequences of pictures in the video data. When video encoder 20 performs the encoding operation for a sequence of pictures, video encoder 20 may generate a series of coded pictures and associated data. In addition, video encoder 20 may generate a sequence parameter set that contains parameters applicable to the sequence of pictures. Furthermore, video encoder 20 may generate picture parameter sets (PPSs) that contain parameters applicable to the pictures as a whole. In some examples, video encoder 20 may generate adaptation parameter sets (APSs). An APS may contain parameters applicable to the picture as a whole.

To generate a coded picture, video encoder 20 may partition a picture into one or more treeblocks (sometimes referred to as a “block”). A treeblock is a two-dimensional (2D) block of video data. In some instances, a treeblock may also be referred to as a largest coding unit (LCU). The treeblocks of HEVC may be broadly analogous to the macroblocks of previous standards, such as H.264/AVC. However, a treeblock is not necessarily limited to a particular size and may include one or more coding units (CUs).

In some examples, video encoder 20 may partition a picture into a plurality of slices. Each of the slices may include an integer number of CUs. In some instances, a slice comprises an integer number of treeblocks. In other instances, a boundary of a slice may be within a treeblock. In some examples, video encoder 20 may encode slices according to the size in bytes of the slices or according to the number of treeblocks in the slices.

As part of performing an encoding operation for a picture, video encoder 20 may perform encoding operations for each slice of the picture. The encoding operation for a slice may generate encoded data associated with the slice. The encoded data associated with the slice may be referred to as a “coded slice.” The coded slice may include a slice header and slice data. The slice data may include a series of successive coding units in coding order. The slice header may contain data elements pertaining to the first or all treeblocks of the slice.

To generate the coded slice data for a slice, video encoder 20 may perform encoding operations on each treeblock in the slice. When video encoder 20 performs the encoding operation on a treeblock, video encoder 20 may generate a coded treeblock. The coded treeblock may comprise data representing an encoded version of the treeblock.

To generate the coded treeblock, video encoder 20 may recursively perform quadtree partitioning on the treeblock to divide the treeblock into progressively smaller CUs. For example, video encoder 20 may partition a treeblock into four equally-sized sub-CUs, partition one or more of the sub-CUs into four equally-sized sub-sub-CUs, and so on. One or more syntax elements in the bitstream may indicate a maximum number of times video encoder 20 may partition a treeblock. A CU may be square in shape.

Video encoder 20 may perform encoding operations on each non-partitioned CU in a treeblock. As part of performing an encoding operation on a non-partitioned CU, video encoder 20 may generate prediction data for the CU. Video encoder 20 may use intra prediction or inter prediction to generate the prediction data for the CU. When video encoder 20 uses intra prediction to generate the prediction data for the CU, video encoder 20 derives the prediction data for the CU from decoded samples of the picture that contains the CU. When video encoder 20 uses inter prediction to generate the prediction data for the CU, video encoder 20 derives the prediction data for the CU from decoded values of reference pictures other than the picture that contains the CU.

After video encoder 20 generates prediction data for a CU, video encoder 20 may calculate residual data for the CU. The residual data for the CU may indicate differences between pixel values in the prediction data for the CU and the original pixel values of the CU.

Each non-partitioned CU of a treeblock may have one or more transform units (TUs). Each TU of a CU may be associated with a different portion of the residual data of the CU. Video encoder 20 may perform a transform operation for each TU of the CU. When video encoder 20 performs the transform operation for a TU, video encoder 20 may generate a coefficient block at least in part by applying a transform to residual data associated with the TU.

Video encoder 20 may quantize the coefficients in a coefficient block and perform an entropy encoding operation on the coefficient block. After video encoder 20 performs entropy encoding on a coefficient block, video encoder 20 may include data representing the entropy encoded coefficient block in the bitstream for the video data. The bitstream may be a sequence of bits that forms a representation of coded pictures and associated data.

When video decoder 30 receives an encoded bitstream, video decoder 30 performs a decoding operation that is generally reciprocal to the encoding operation performed by video encoder 20. For instance, video decoder 30 may perform a decoding operation on each slice of the picture. When video decoder 30 performs the decoding operation on a slice of the picture, video decoder 30 may perform decoding operations on the treeblocks in the slice. When video decoder 30 completes the decoding operation on a treeblock, video decoder 30 has decoded the pixel values for the treeblock. When video decoder 30 has decoded the pixel values for each treeblock of a slice, video decoder 30 has reconstructed the pixel values for the slice.

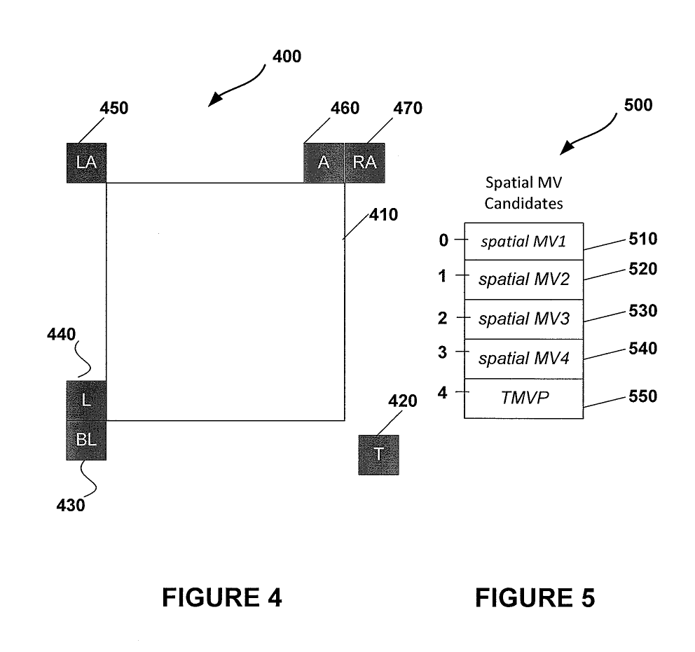

Merge mode refers to one or more video coding modes in which motion information (such as motion vectors, reference frame indexes, prediction directions, or other information) of a neighboring video block are inherited for a current video block being coded. An index value may be used to identify a list of candidate neighbors from which the current video block inherits its motion information (e.g., a top, top right, left, left bottom block, relative to the current block, or a co-located block from a temporally adjacent frame (such as a temporal motion vector predictor, or TMVP, as discussed in greater detail, below). These candidates may be stored in a list, sometimes referred to as a merge candidate list. The merge candidate list can initially have a predetermined size. However, the list size may be reduced as a result of pruning (e.g., removing redundant or repeating list entries) or by truncation (e.g., if the video is coded to use a particular merge candidate list size). As the list size is reduced and candidates are deleted (or in situations that more candidates are inserted before TMVP), the TMVP may be removed from the list or not added to the list in some cases. However, various techniques, such as those described in greater detail below, may be utilized to ensure that the TMVP remains in the merge candidate list, even after the list is pruned or truncated. Embodiments of such techniques are described in greater detail below with respect to FIGS. 4 through 15.

Skip mode may comprise one type of merge mode (or a mode similar to merge mode). With skip mode, motion information is inherited, but no residual information is coded. Residual information may generally refer to pixel difference information indicating pixel differences between the block to be coded and the block from which the motion information is inherited. Direct mode may be another type of merge mode (or mode similar to merge mode). Direct mode may be similar to skip mode in that motion information is inherited, but with direct mode, a video block is coded to include residual information. The phrase “merge mode” is used herein to refer to any one of these modes, which may be called skip mode, direct mode or merge mode.

Another case where the motion vector of a neighboring video block is used in the coding of a current video block is so-called motion vector prediction or advanced motion vector prediction (AMVP). In these cases, predictive coding of motion vectors is applied to reduce the amount of data needed to communicate the motion vector. For example, rather than encoding and communicating the motion vector itself, video encoder 20 encodes and communicates a motion vector difference (MVD) relative to a known (or knowable) motion vector. In H.264/AVC, the known motion vector, which may be used with the MVD to define the current motion vector, can be defined by a so-called motion vector predictor (MVP), which is derived as the median of motion vectors associated with neighboring blocks. However, more advanced MVP techniques, such as adaptive motion vector prediction (AMVP) may allow video encoder 20 to select the neighbor from which to define the MVP. Hence, the use of merge mode may refer to the use of motion information from another block to code a current block, with or without residual information indicating pixel differences between the block to be coded and the other block. The use of AMVP may refer to the use of motion vector information from another block, with the use of an MVD value to indicate the differences between the MVP and the actual MV of the block to be coded. Techniques for selection of a candidate block to obtain motion vector information may be the same or similar for merge mode and AMVP. As general background, in most video coding systems, motion estimation and motion compensation are used to reduce the temporal redundancy in a video sequence, in order to achieve data compression. In this case, a motion vector can be generated so as to identify a predictive block of video data, e.g., from another video frame or slice, which can be used to predict the values of the current video block being coded. The values of the predictive video block are subtracted from the values of the current video block to produce a block of residual data. The motion vector is communicated from video encoder 20 to video decoder 30, along with the residual data. Video decoder 30 can locate the same predictive block (based on the motion vector) and reconstruct the encoded video block by combining the residual data with the data of the predictive block. Many other compression techniques can also be used, such as transforms and entropy coding, to further improve the video compression.

Video encoder 20 usually performs the motion estimation process. Video encoder 20 may transmit motion information (such as motion vectors, motion vector indexes, prediction directions, or other information) to video decoder 30 so that video decoder 30 is able to identify a predictive block used to encode a given video block.

AMVP has been proposed to build a motion vector candidate set by including several neighboring blocks in spatial and temporal directions as candidates for MVP. In this case, video encoder 20 selects the most accurate predictor from the candidate set based on analysis of encoding rate and distortion (e.g., using so-called rate-distortion cost analysis). Video encoder 20 may also signal a motion vector predictor index (mvp_idx) to video decoder 30 to inform video decoder 30 where to locate the MVP. Video encoder 20 may also signal the MVD. Video decoder 30 may combine the MVD with the MVP (defined by the motion vector predictor index) so as to reconstruct the motion vector. Video decoder 30 (like video encoder 20) may define the set of candidate MVPs to which the index is applied based on various criteria.

### Video Encoder

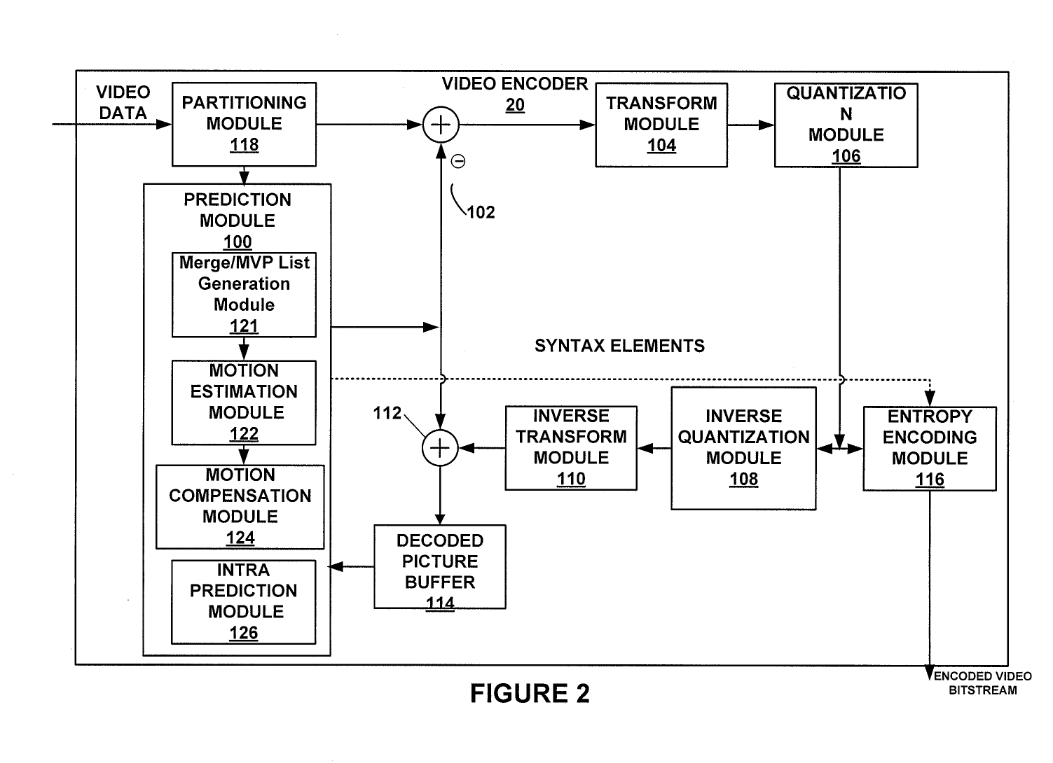

In the example of FIG. 2, video encoder 20 includes a plurality of functional components. The functional components of video encoder 20 include a prediction module 100, a residual generation module 102, a transform module 104, a quantization module 106, an inverse quantization module 108, an inverse transform module 110, a reconstruction module 112, and a decoded picture buffer 114, an entropy encoding module 116, and a partitioning module 118. Prediction module 100 includes a motion estimation module 122, a motion compensation module 124, and an intra-prediction module 126.

In other examples, video encoder 20 may include more, fewer, or different functional components. For example, video encoder 20 may include a deblocking filter to filter the output of reconstruction module 112 to remove blockiness artifacts from reconstructed video. Furthermore, motion estimation module 122 and motion compensation module 124 may be highly integrated, but are represented in the example of FIG. 2 separately for purposes of explanation.

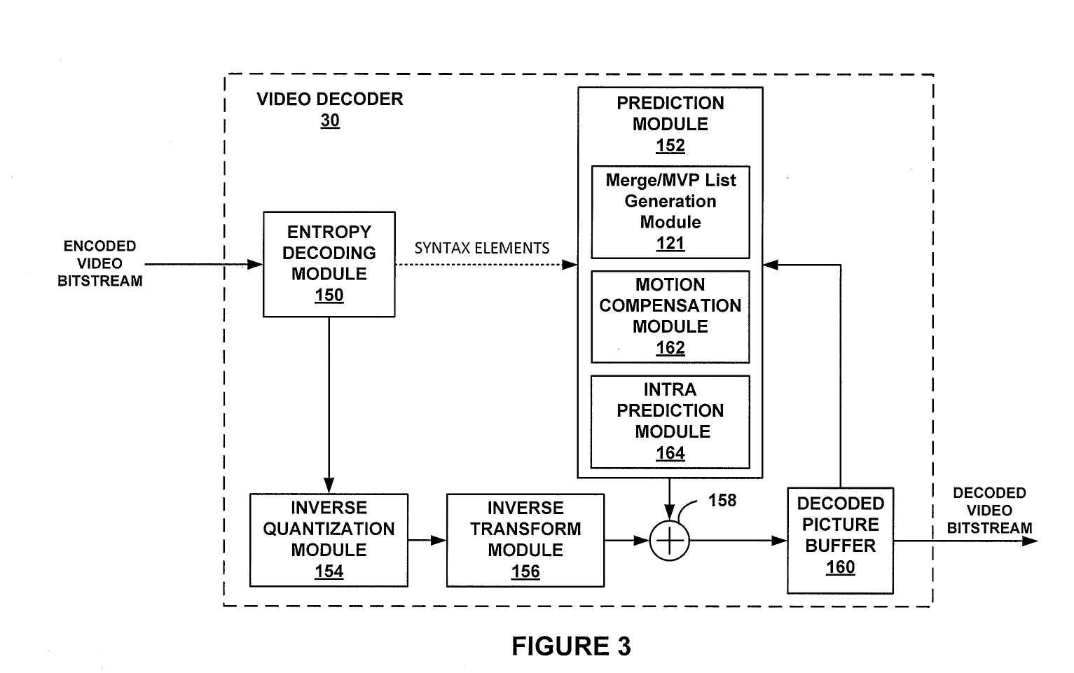

Video encoder 20 may receive video data. In various examples, video encoder 20 may receive the video data from various sources. For example, video encoder 20 may receive the video data from video source 18 (FIG. 3) or another source. The video data may represent sequences of pictures. The pictures may include texture view and depth views. To encode the video data, video encoder 20 may perform an encoding operation on each sequence of pictures. As part of performing the encoding operation on a sequence of pictures, video encoder 20 may perform encoding operations on each picture within the sequence of pictures. As part of performing the encoding operation on a picture, video encoder 20 may perform encoding operations on each slice in the picture. When video encoder 20 performs an encoding operation on a slice, video encoder 20 generates a coded slice. The coded slice is the slice in its encoded form. The coded slice may include a slice header and slice data. The slice header may contain syntax elements associated with the slice.

As part of performing an encoding operation on a slice, video encoder 20 may perform encoding operations on treeblocks in the slice. When video encoder 20 performs an encoding operation on a treeblock, video encoder 20 may generate a coded treeblock. The coded treeblock may comprise data representing an encoded version of a treeblock. In other words, the coded treeblock may be a treeblock in its encoded form.

As part of performing an encoding operation on a treeblock, partitioning module 118 may perform quadtree partitioning on the treeblock to divide the treeblock into progressively smaller CUs. For example, partitioning module 118 may partition a treeblock into four equally-sized sub-CUs, partition one or more of the sub-CUs into four equally-sized sub-sub-CUs, and so on.

The sizes of the CUs may range from 8×8 pixels up to the size of the treeblock with a maximum of 64×64 pixels or greater. In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value.

As part of performing the encoding operation for a treeblock, partitioning module 118 may generate a hierarchical quadtree data structure for the treeblock. For example, a treeblock may correspond to a root node of the quadtree data structure. If partitioning module 118 partitions the treeblock into four sub-CUs, the root node has four child nodes in the quadtree data structure. Each of the child nodes corresponds to one of the sub-CUs. If partitioning module 118 partitions one of the sub-CUs into four sub-sub-CUs, the node corresponding to the sub-CU may have four child nodes, each of which corresponds to one of the sub-sub-CUs.

Each node of the quadtree data structure may provide syntax data for the corresponding CU. For example, a node in the quadtree may include a split flag, indicating whether the CU corresponding to the node is partitioned (e.g., split) into four sub-CUs. Syntax elements for a CU may be defined recursively, and may depend on whether the CU is split into sub-CUs. A CU that is not partitioned may correspond to a leaf node in the quadtree data structure. A leaf node in the quadtree data structure may be referred to as a “coding node.” A coded treeblock may include data based on the quadtree data structure for a corresponding treeblock. A coded treeblock is a treeblock in its encoded form. A coded treeblock corresponds to a treeblock when the coded treeblock is the treeblock in its encoded form.

Video encoder 20 may perform encoding operations on each non-partitioned CU of the treeblock. When video encoder 20 performs an encoding operation on a non-partitioned CU, video encoder 20 generates data representing an encoded version of the non-partitioned CU.

As part of performing an encoding operation on a CU, motion estimation module 122 and motion compensation module 124 may perform inter prediction on the CU. In other words, motion estimation module 122 and motion compensation module 124 may generate prediction data for the CU based on decoded samples of reference pictures other than the picture that contains the CU. Inter prediction may provide temporal compression.

To perform inter prediction on a CU, motion estimation module 122 may partition the CU into one or more prediction units (PUs). Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, motion estimation module 122 may partition a CU into PUs along a boundary that does not meet the sides of the CU at right angles.

Motion estimation module 122 may perform a motion estimation operation with regard to each PU of a CU. When motion estimation module 122 performs a motion estimation operation with regard to a PU, motion estimation module 122 may generate one or more motion vectors for the PU. For instance, slices may be I slices, P slices, or B slices. Motion estimation module 122 and motion compensation module 124 may perform different operations for a PU of a CU depending on whether the CU is in an I slice, a P slice, or a B slice. In an I slice, all CUs are intra predicted. Hence, if the CU is in an I slice, motion estimation module 122 and motion estimation module 124 do not perform inter prediction on the CU.

If the CU is in a P slice, the picture containing the CU is associated with a list of reference pictures referred to as “list 0.” Each of the reference pictures in list 0 contains samples that may be used for inter prediction of subsequent pictures in decoding order. When motion estimation module 122 performs the motion estimation operation with regard to a PU in a P slice, motion estimation module 122 searches the reference pictures in list 0 for a reference sample for the PU. The reference sample of the PU may be a set of pixel values that most closely corresponds to the pixels values of the PU. Motion estimation module 122 may use a variety of metrics to determine how closely a set of pixel values in a reference picture corresponds to the pixel values of a PU. For example, motion estimation module 122 may determine how closely a set of pixel values in a reference picture corresponds to the pixel values of a PU by sum of absolute difference (SAD), sum of square difference (SSD), or other difference metrics.

After identifying a reference sample of a PU of a CU in a P slice, motion estimation module 122 may generate a reference index that indicates the reference picture in list 0 containing the reference sample and a motion vector that indicates a spatial displacement between the PU and the reference sample. In various examples, motion estimation module 122 may generate motion vectors to varying degrees of precision. For example, motion estimation module 122 may generate motion vectors at one-quarter pixel precision, one-eighth pixel precision, or other fractional pixel precision. Motion estimation module 122 may output motion information for the PU to entropy encoding module 56 and motion compensation module 124. The motion information for the PU may include the reference index and the motion vector of the PU. Motion compensation module 124 may use the motion information of PUs of the CU to identify and retrieve the reference samples of the PUs. Motion compensation module 124 may then use pixel values of reference samples of PUs to generate the prediction data for the CU.

If the CU is in a B slice, the picture containing the CU may be associated with two lists of reference pictures, referred to as “list 0” and “list 1.” Each of the reference pictures in list 0 contains samples that may be used for inter prediction of subsequent pictures in decoding order. The reference pictures in list 1 occur before the picture in decoding order but after the picture in presentation order. In some examples, a picture containing a B slice may be associated with a list combination that is a combination of list 0 and list 1.

Furthermore, if the CU is in a B slice, motion estimation module 122 may perform uni-directional prediction or bi-directional prediction for PUs of the CU. When motion estimation module 122 performs uni-directional prediction for a PU, motion estimation module 122 may search the reference pictures of list 1 for a reference sample for the PU. Motion estimation module 122 may then generate a reference index that indicates the reference picture in list 1 that contains the reference sample and a motion vector that indicates a spatial displacement between the PU and the reference sample. Motion estimation module 122 may output motion information for PUs of the CU to entropy encoding module 56 and motion compensation module 124. The motion information for the PU may include the reference index, a prediction direction indicator, and the motion vector of the PU. The prediction direction indicator may indicate whether the reference index indicates a reference picture in list 0 or list 1. Motion compensation module 124 may use the motion information of PUs of the CU to identify and retrieve the reference samples of the PUs. Motion compensation module 124 may then use pixel values of reference samples of PUs to generate the prediction data for the CU.

When motion estimation module 122 performs bi-directional prediction for a PU, motion estimation module 122 may search the reference pictures in list 0 for a reference sample for the PU and may also search the reference pictures in list 1 for another reference sample for the PU. Motion estimation module 122 may then generate reference indexes that indicate the reference samples and motion vectors that indicate spatial displacements between the reference samples and the PU. Motion estimation module 122 may output motion information of the PU to entropy encoding module 56 and motion compensation module 124. The motion information for the PU may include the reference indexes and the motion vectors of the PU. Motion compensation module 124 may use the motion information to identify and retrieve the reference samples of the PUs. Motion compensation module 124 may then interpolate pixel values of the prediction data of the CU from pixel values in the reference samples of the PUs of the CU.

In some instances, motion estimation module 122 does not output a full set of motion information for the PU to entropy encoding module 56. Rather, motion estimation module 122 may signal the motion information of a PU with reference to the motion information of another PU. For example, motion estimation module 122 may determine that the motion information of the PU is sufficiently similar to the motion information of a neighboring PU. In this example, motion estimation module 122 may indicate, in a quadtree node for the CU, a value that indicates to video decoder 30 that the PU has the same motion information as the neighboring PU. In another example, motion estimation module 122 may identify, in a quadtree node associated with the CU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to predict the motion vector of the PU.

As part of performing an encoding operation on a CU, intra prediction module 46 may perform intra prediction on the CU. In other words, intra prediction module 46 may generate prediction data for the CU based on decoded pixel values of other CUs. Intra prediction may provide spatial compression.

To perform intra prediction on a CU, intra prediction module 46 may use multiple intra prediction modes to generate multiple sets of prediction data for the CU. When intra prediction module 46 uses an intra prediction mode to generate a set of prediction data for a CU, intra prediction module 46 may extend pixel values from neighboring CUs across the CU in a direction and/or gradient associated with the intra prediction mode. The neighboring CUs may be above, above and to the right, above and to the left, or to the left of the CU, assuming a left-to-right, top-to-bottom encoding order for CUs and treeblocks. Intra prediction module 46 may use various numbers of intra prediction modes, e.g., 33 directional intra prediction modes, depending on the size of the CU.

Intra prediction module 46 may select one of the sets of prediction data for the CU. In various examples, intra prediction module 46 may select the set of prediction data for the CU in various ways. For example, intra prediction module 46 may select the set of prediction data for the CU by calculating distortion rates for the sets of prediction data and selecting the set of prediction data that has the lowest distortion rate.

Prediction module 100 may select the prediction data for a CU from among the prediction data generated by motion compensation module 124 for the CU or the prediction data generated by intra prediction module 126 for the CU. In some examples, prediction module 100 selects the prediction data for the CU based on error (e.g., distortion) in the sets of prediction data.

After prediction module 100 selects the prediction data for a CU, residual generation module 102 may generate residual data for the CU by subtracting the selected prediction data of the CU from the pixel values of the CU. The residual data of a CU may include 2D residual blocks that correspond to different pixel components of the pixels in the CU. For example, the residual data may include a residual block that corresponds to differences between luminance components of pixels in the prediction data of the CU and luminance components of pixels in the original pixels of the CU. In addition, the residual data of the CU may include residual blocks that correspond to the differences between chrominance components of pixels in the prediction data of the CU and the chrominance components of the original pixels of the CU.

A CU may have one or more transform units (TUs). Each TU of a CU may correspond to a different portion of the residual data of the CU. The sizes of the TUs of a CU may or may not be based on the sizes of PUs of the CU. In some examples, a CU may be subdivided into smaller units using a quadtree structure known as a “residual quad tree” (RQT). The TUs may correspond to nodes of the RQT.

Transform module 104 may generate one or more coefficient blocks for each non-partitioned TU of a CU by applying a transform to the residual data corresponding to the non-partitioned TU. Each of the coefficient blocks may be a 2D matrix of coefficients. In various examples, transform module 104 may apply various transforms to the residual data corresponding to a TU. For example, transform module may apply a discrete cosine transform (DCT), a directional transform, or a conceptually similar transform.

After transform module 104 generates a coefficient block for a TU, quantization module 106 may quantize the coefficients in the coefficient block. Quantization generally refers to a process in which coefficients in a coefficient block are quantized to possibly reduce the amount of data used to represent the coefficients, providing further compression. Quantization may reduce the bit depth associated with some or all of the coefficients. For example, an n-bit value may be rounded down to an m-bit value during quantization, where n is greater than m.

Inverse quantization module 108 and inverse transform module 110 may apply inverse quantization and inverse transformation to the coefficient block, respectively, to reconstruct residual data from the coefficient block. Reconstruction module 112 may add the reconstructed residual data to the prediction data generated by motion compensation module 124 or intra prediction module 126 to produce a reconstructed video block for storage in decoded picture buffer 114. Motion estimation module 122 and motion compensation module 124 may use a reference picture that contains the reconstructed video block to perform inter prediction on CUs of subsequent pictures. In addition, intra prediction module 126 may use reconstructed pixel values of CUs of the current picture to perform intra prediction.

Entropy encoding module 116 may receive data from other functional components of video encoder 20. For example, entropy encoding module 116 may coefficient blocks from quantization module 106 and may receive syntax elements from prediction module 100. When entropy encoding module 116 receives data, entropy encoding module 116 may perform one or more entropy encoding operations to generate entropy encoded data. For example, video encoder 20 may perform a context adaptive variable length coding (CAVLC) operation, a Context-Adaptive Binary Arithmetic Coding (CABAC) operation, a syntax-based context-adaptive binary arithmetic coding (SBAC) operation, a Probability Interval Partitioning Entropy (PIPE) coding operation, or another type of entropy encoding operation on the data.

To perform CABAC, entropy encoding module 116 may assign a context within a context model to a symbol to be transmitted. The context may relate to, for example, whether neighboring values of the symbol are non-zero or not. To perform CAVLC, entropy encoding module 116 may select a variable length code for a symbol to be transmitted. Codewords in VLC may be constructed such that relatively short codes correspond to more probable symbols, while relatively long codes correspond to less probable symbols. In this way, the use of VLC may achieve a bit savings over using equal-length codewords for each symbol to be transmitted. The probability determination may be based on a context assigned to the symbol.

Entropy encoding module 116 may output a bitstream. The bitstream may be a sequence of bits that forms a representation of coded pictures and associated data. The bitstream may comprise a sequence of network abstraction layer (NAL) units. Each of the NAL units may be a syntax structure containing an indication of a type of data in the NAL unit and bytes containing the data. For example, a NAL unit may contain data representing a PPS, an APS, a coded slice, supplemental enhancement information, an access unit delimiter, filler data, or another type of data. The data of a NAL unit may be in the form of a raw byte sequence payload (RBSP) interspersed with emulation prevention bits. A RBSP may be a syntax structure containing an integer number of bytes that is encapsulated within a NAL unit.

Entropy encoding module 116 outputs a bitstream that includes a series of NAL units. As discussed above, each of the NAL units may be a syntax structure containing an indication of a type of data in the NAL unit and bytes containing the data. Each coded slice NAL unit in the bitstream contains a coded slice. A coded slice includes a coded slice header and slice data. The slice data may include coded treeblocks. The coded treeblocks may include one or more coded CUs. Each coded CU may include one or more entropy-encoded coefficient blocks.

### Video Decoder

FIG. 3 is a block diagram that illustrates an example configuration of video decoder 30. FIG. 5 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 3, video decoder 30 includes a plurality of functional components. The functional components of video decoder 30 include an entropy decoding module 150, a prediction module 152, an inverse quantization module 154, an inverse transform module 156, a reconstruction module 158, and a decoded picture buffer 160. Prediction module 152 includes a merge/MVP list generation module 121, a motion compensation module 162 and an intra prediction module 164. The merge/MVP list generation module 121 may reorder MV candidate lists and the MVP candidate lists so that TMVP may be included in the merge candidate lists or the MVP candidate lists. In some examples, video decoder 30 may perform a decoding pass generally reciprocal to the encoding pass described with respect to video encoder 20 of FIG. 2. In other examples, video decoder 30 may include more, fewer, or different functional components. For example, video decoder 30 may include a deblocking filter to filter the output of reconstruction module 158 to remove blockiness artifacts from reconstructed video.

Video decoder 30 may receive a bitstream that comprises encoded video data. When video decoder 30 receives the bitstream, entropy decoding module 150 performs a parsing operation on the bitstream. As a result of performing the parsing operation on the bitstream, entropy decoding module 150 may generate entropy-decoded syntax elements. The entropy-decoded syntax elements may include entropy-decoded coefficient blocks. Prediction module 152, inverse quantization module 154, inverse transform module 156, and reconstruction module 158 may perform a decoding operation that uses the syntax elements to generate decoded video data. The merge/MVP list generation module 121 in the prediction module 152 may reorder MV candidate lists and the MVP candidate lists so that TMVP may be included in the merge candidate lists or the MVP candidate lists.

As discussed above, the bitstream may comprise a series of NAL units. The NAL units of the bitstream may include sequence parameter set NAL units, picture parameter set NAL units, SEI NAL units, and so on. As part of performing the parsing operation on the bitstream, entropy decoding module 150 may perform parsing operations that extract and entropy decode sequence parameter sets from sequence parameter set NAL units, picture parameter sets from picture parameter set NAL units, SEI data from SEI NAL units, and so on. A sequence parameter set is a syntax structure that contains syntax elements that apply to zero or more entire coded video sequences. A picture parameter set is a syntax structure containing syntax elements that apply to zero or more entire coded pictures. A picture parameter set associated with a given picture may include a syntax element that identifies a sequence parameter set associated with the given picture.

In addition, the NAL units of the bitstream may include coded slice NAL units. As part of performing the parsing operation on the bitstream, entropy decoding module 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding module 150 may perform an entropy decoding operation, such as a CAVLC decoding operation, on the coded slice header to recover the slice header.

After extracting the slice data from coded slice NAL units, entropy decoding module 150 may extract coded treeblocks from the slice data. Entropy decoding module 150 may then extract coded CUs from the coded treeblocks. Entropy decoding module 150 may perform parsing operations that extract syntax elements from the coded CUs. The extracted syntax elements may include entropy-encoded coefficient blocks. Entropy decoding module 150 may then perform entropy decoding operations on the syntax elements. For instance, entropy decoding module 150 may perform CABAC operations on the coefficient blocks.

When entropy decoding module 150 performs an entropy decoding operation on a set of data, entropy decoding module 150 may select a context model. In examples where entropy decoding module 150 uses CABAC, the context model may indicate probabilities of particular bins. In examples where entropy decoding module 150 uses CAVLC, the context model may indicate a mapping between codewords and the corresponding data. Entropy decoding module 150 may then use the selected context model to perform the entropy decoding operation on the set of data.

After entropy decoding module 150 performs a parsing operation on a non-partitioned CU, video decoder 30 may perform a decoding operation on the non-partitioned CU. To perform the decoding operation on a non-partitioned CU, video decoder 30 may, at each level of the residual quadtree of the CU, perform a decoding operation on each TU of the CU. By performing the decoding operation for each TU of the CU, video decoder 30 may reconstruct the residual data of the CU.

As part of performing a decoding operation on a non-partitioned TU, inverse quantization module 154 may inverse quantize, i.e., de-quantize, the coefficient blocks associated with the TU. Inverse quantization module 154 may inverse quantize the coefficient blocks in a manner similar to the inverse quantization processes proposed for HEVC or defined by the H.264 decoding standard. Inverse quantization module 154 may use a quantization parameter QPY calculated by video encoder 20 for a CU of the coefficient block to determine a degree of quantization and, likewise, a degree of inverse quantization for inverse quantization module 154 to apply.

After inverse quantization module 154 inverse quantizes a coefficient block, inverse transform module 156 may generate residual data for the TU associated with the coefficient block. Inverse transform module 156 may generate the residual data for the TU at least in part by applying an inverse transform to the coefficient block. For example, inverse transform module 156 may apply an inverse DCT, an inverse integer transform, an inverse Karhunen-Loeve transform (KLT), an inverse rotational transform, an inverse directional transform, or another inverse transform to the coefficient block. In some examples, inverse transform module 156 may determine an inverse transform to apply to the coefficient block based on signaling from video encoder 20. In such examples, inverse transform module 156 may determine the inverse transform based on a signaled transform at the root node of a quadtree for a treeblock associated with the coefficient block. In other examples, inverse transform module 156 may infer the inverse transform from one or more coding characteristics, such as block size, coding mode, or the like. In some examples, inverse transform module 156 may apply a cascaded inverse transform.

If the CU was encoded using inter prediction, motion compensation module 162 may perform motion compensation to generate prediction data for the CU. Motion compensation module 162 may use motion information for the PUs of the CU to identify reference samples for the PUs. The motion information for a PU may include a motion vector, a reference picture index, and a prediction direction. Motion compensation module 162 may then use the reference samples for the PUs to generate prediction data for the CU.

In some examples, motion compensation module 162 may refine the prediction data for a CU by performing interpolation based on interpolation filters. Identifiers for interpolation filters to be used for motion compensation with sub-pixel precision may be included in the syntax elements. Motion compensation module 162 may use the same interpolation filters used by video encoder 20 during generation of the prediction data of the CU to calculate interpolated values for sub-integer pixels of a reference block. Motion compensation module 162 may determine the interpolation filters used by video encoder 20 according to received syntax information and use the interpolation filters to produce prediction data.

If a CU is encoded using intra prediction, intra prediction module 164 may perform intra prediction to generate prediction data for the CU. For example, intra prediction module 164 may determine an intra prediction mode for the CU based on syntax elements in the bitstream. Intra prediction module 164 may then use the intra prediction mode to generate prediction data (e.g., predicted pixel values) for the CU based on the pixel values of neighboring CUs.

Reconstruction module 158 may use the residual data of a CU and the prediction data for the CU to reconstruct pixel values for the CU. In some examples, video decoder 30 may apply a deblocking filter to remove blockiness artifacts from the reconstructed pixel values filter of a slice or picture. Decoded picture buffer 160 may store the decoded pixel values for pictures of the video data. Decoded picture buffer 160 may provide reference pictures for subsequent motion compensation, intra prediction, and presentation on a display device, such as display device 34 of FIG. 3. It is to be recognized that depending on the embodiment, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

### Merge Motion Vector (MV) Candidates

As discussed above, during certain coding modes, a list of motion vector candidates may be generated and one or more of the motion vectors may be used to determine the value of a current video block. The motion vector candidates may include motion vector information from one or more spatially neighboring video blocks (e.g., below-left (BL 430), left (L 440), left-above (LA 450), above (A 460), and right-above (RA 470)) as well as one temporally neighboring, co-located video block (e.g., a temporal motion vector predictor, or TMVP (T 420)). These spatially neighboring video blocks 430, 440, 450, 460, 470 and the TMVP 420 are illustrated in FIG. 4. In some embodiments, the current video block 410 (e.g., the video block that is being coded) may inherit or otherwise use the motion information (e.g., motion vectors) of a selected neighboring video block. For example, as illustrated in FIG. 4, video encoder (such as video encoder 20) does not signal the motion vector itself for a video block 410 coded in merge mode. Rather, an index value (e.g., index values 0 to 4, as shown in FIG. 5) may be used to identify the neighboring video blocks (such as a bottom-left neighbor 430, left neighbor 440, left-above neighbor 450, above neighbor 460, or right-above neighbor 470) from which the current video block 410 inherits its motion vector and motion information.

In the merge mode, a merge motion vector (MV) candidate list is typically generated. One example of a merge motion candidate list 500 is illustrated in FIG. 5. In some embodiments, the merge candidate list size value N (e.g., the maximum number of list entries) of the merge candidate list may be signaled (e.g., at a slice header, etc.). According to the current version of the HEVC specification, a merge MV candidate list size cannot be greater than five. However, in some embodiments of this disclosure, the merge candidate list size N may be greater than five.

In some embodiments, a merge MV candidate list 500 may include one or more of the motion vectors of spatial neighbor blocks 430, 440, 450, 460, 470 and a temporally co-located block (e.g., TMVP) 420, as shown in FIG. 4. Four of the five spatial MV candidates and the temporal MV candidate are stored as entries 510, 520, 530, 540, 550 in a merge MV candidate list 500, as shown in FIG. 5.

FIG. 5 shows an illustrative example of a merge candidate list 500 (also called a merge MV candidate list or a MV candidate list 500) having five entries and up to four spatial motion vector candidates added to the merge candidate list (although in other embodiments, the candidate list may have more or less than five entries and have more or less than four spatial candidates added to the merge candidate list). Index values for the five entries in the merge candidate list 500 start at 0 and end at 4. The merge candidates may include spatial candidates, for example as defined in HEVC, and other types of candidates. As shown in FIG. 5, the TMVP 550 may be added after spatial candidates at the end of the list 500, and may have an index value of 4. Four other spatial motion vector candidates, if available (e.g., containing valid motion information), are added into the list 500:spatial MV1 510, which may have an index of 0; spatial MV2 520, which may have an index of 1; spatial MV3 530, which may have an index of 2; and spatial MV4 540, which may have an index of 3. Each spatial MV can be equal to or derived from any spatially neighboring video block (e.g., blocks 430, 440, 450, 460, 470) to the current video block (e.g., block 410). In some embodiments, if some merge candidates are not available, (or if they are pruned or otherwise removed from the list 500) other candidates can be added to the list. For example spatial candidate from block 450 may be added. In some embodiments, if some merge candidates are not available, the TMVP 550 may have an index less than 4.

Some merge candidates in the merge MV candidate list 500 may be compared with other merge candidates to determine if values have been duplicated. MV candidates can be removed from the merge MV candidate list 500 if the same MV is already present in the merge MV candidate list 500. This process may be referred to as pruning. For example, even if five MV candidates are added to the merge MV candidate list 500, after the pruning process, the total number of unique MV candidates could be smaller than five. If the total number of MV candidates after pruning is less than five, additional artificial candidates, based on the ones already inserted in the merge MV candidate list 500, may be generated to fill up the MV candidate list 500. As a result, a merge candidate list may be generated, and a video encoder (e.g., video encoder 20) may signal, in the encoded video bitstream, an index, corresponding to the selected MV candidates from the merge candidate list, in the bitstream to video decoder 30. The merge list of five candidates is used for illustrative purposes. Other numbers of candidates can also be used.

### Reordering the Merge MV Candidate List to Include the TMVP

According to the HEVC standard, merge candidate lists are typically constructed as described above, regardless of the merge candidate list size N, which may be signaled (e.g., in a slice header). If N is smaller than five, the first N candidates in the merge MV candidate list 500 will be used in the merge/skip mode, but the remaining candidates will be disregarded. In such situations, the TMVP 550 (which is added after spatial MV candidates and can be the last in the list) is likely to have an index value greater than N and therefore disregarded. In some situations, coding performance may be seriously degraded if the TMVP is not included in the merge candidate list.

In another example, if the total number of candidates added prior to TMVP is greater than N−1, the TMVP may not be included in the merge candidate list. To make sure that the TMVP is included in the merge candidate list, a technique of according to this disclosure may check whether a condition is satisfied in association with each added merge candidate. In one embodiment, the condition is whether the index m of the newly added candidate is less than N−1 (m starts at 0; if m starts at 1, then the condition is whether m is less than N), so that the slot that could be the last slot in the merge list may be reserved for the TMVP. The merge candidate list size N may be 5 or a different number. The pruning process may be performed on the candidates added prior to the TMVP.

The techniques of this disclosure are configured to make sure that a Temporal Motion Vector Predictor (“TMVP”) is included in a merge candidate list. For instance, a video coding device may include a memory configured to store an initial list of motion vector candidates and a TMVP, and a processor in communication with the memory. The processor may be configured to receive a merge candidate list size value (N), identify one or more motion vector candidates to include in a merge candidate list having a list size equal to N, and generate the merge candidate list such that the merge candidate list includes the TMVP, regardless of the list size N. In some embodiments, this TMVP inclusion may depend on list size N. The merge candidate list may be a merge motion vector (MV) candidate list or a motion vector predictor (MVP) candidate list (also known as an AMVP candidate list).

According to some aspects of this disclosure, the processor may generate a bitstream that includes encoded video data, and the bitstream may be encoded such that each merge candidate list in the bitstream includes a TMVP if a TMVP is available, regardless of the list size. In some embodiments, a TMVP may not be available, for example, if the co-located block is intra coded and does not contain a motion vector.

Moreover, the processor may obtain such a bitstream that each merge candidate list in the bitstream includes a TMVP if a TMVP is available, regardless of the list size, and the processor may decode the video data using the merge candidate list in the bitstream.

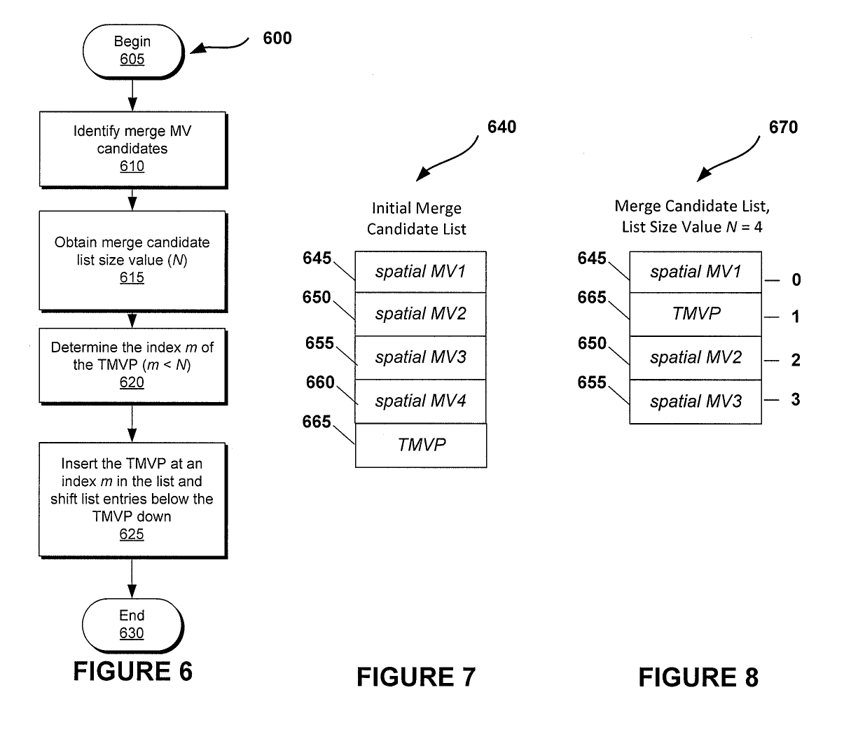

FIG. 6 is a flowchart that illustrates an embodiment of a process 600 of reordering a merge candidate list. The process 600 starts at block 605. At block 610, merge MV candidates are identified. The process 600 then continues to block 615, and the merge candidate list size value (N) is obtained. The process 600 then continues to block 620, and determines the index m of the TMVP. The index starts at 0, which indicates the first position in a merge candidate list, and continues to N−1, which indicates the last position in the merge candidate list. In other embodiments, the index may start at 1 and continue to N. At block 620, the index m is set to an integer value (e.g., less than or equal to N−1 if the index starts at 0, or less than or equal to N if the index starts at 1) to make sure the TMVP is included in the merge candidate list. In some embodiments, coding performance may be improved if the TMVP is not only included in the merge candidate list, but also if it is included as the last, or near the last entry. The process 600 then continues to block 625, where the TMVP is inserted in the index m in the merge candidate list. All the list entries that were at or below the index m are shifted down (e.g., their index positions are each increased by one). The process 600 ends at block 630.

In some embodiments, a position in the merge candidate list is reserved for the TMVP. For example, if the merge candidate list size value is N, a space may be reserved for the TMVP at any position with an index m that is smaller than N. Moreover, in some cases, the position of the TMVP in the merge candidate list may be fixed at the position with an index N−1. This ensures that a space is reserved for the TMVP in the merge candidate list.

FIG. 7 is an illustrative example of an initial merge candidate list 640 prior to reordering. The initial merge candidate list 640 includes four spatial MV candidates 645, 650, 655, 660 and a TMVP 665. Other types of motion vector candidates may be used as well, such as base layer motion vector candidates, base view or disparity motion vector candidates. They may be added to the list before TMVP.

FIG. 8 is an illustrative example of an embodiment of a merge candidate list 670 after reordering the initial merge candidate list 640. In this example, because the merge candidate list size value N is only four (N=4). Spatial MV4 660, which was an initial merge MV candidate, is not included in the merge candidate list 670. Without the reordering, the TMVP 665 would have been left out of the merge candidate list 670, which could adversely affect coding performance. Other types of motion vector candidates may be used as well, such as base layer motion vector candidates, base view or disparity motion vector candidates. They may be added to the list before TMVP.

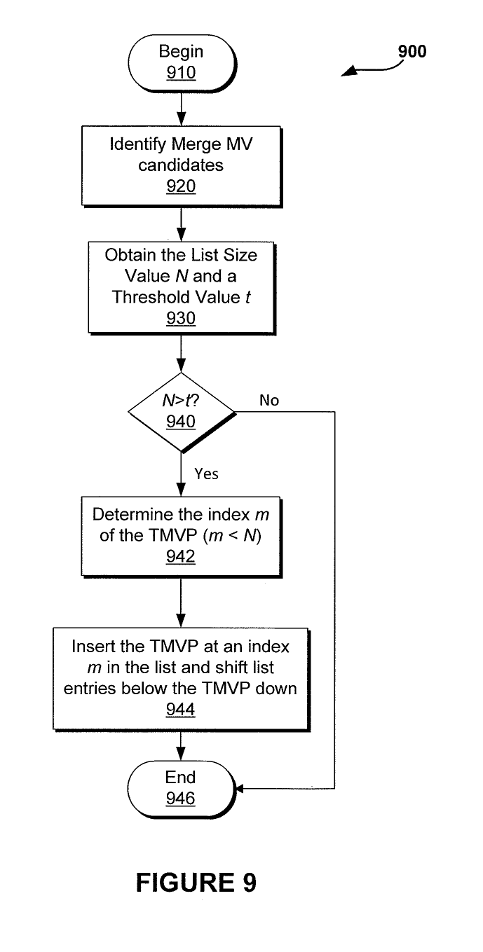

Using a reordering process 600, however, the index m of the TMVP 665 is set to a value less than N−1 (e.g., in the illustrated example, the TMVP 665 index value is set to m=1), which means the TMVP 665 is inserted in the second position in the merge candidate list 670. Spatial MV1 645 remains at the same position as in the initial merge candidate list 640, with an index of 0. Because of the insertion of the TMVP 665, spatial MV2 650 is shifted from its original second position (from index position 1) in the initial merge candidate list 640 down to the third position (to index position 2) in the merge candidate list 670. Likewise, spatial MV3 655 is also shifted from its original position as the third item in the initial merge candidate list 640 (from index position 2) down to the fourth and final position (at index position 3) in the merge candidate list 670. In some embodiments, other types of motion vector candidates may be used as well, such as base layer motion vector candidates, base view or disparity motion vector candidates. They may be added to the list before TMVP. FIG. 9 is a flowchart that illustrates an embodiment of a process of reordering a merge candidate list when the merge candidate list size value (N) is greater than a threshold value (t). In some embodiments, the threshold value (t) may be derived from neighboring blocks. In other embodiments, the threshold value (t) may be signaled at PU, CU, LCU, group of CU levels, or in a sequence parameter set (SPS), picture parameter set (PPS), and/or adaptation parameter set (APS) headers.

The process 900 starts at block 910. At block 920, spatial MV candidates are identified. The process 900 then continues to block 930, where the merge candidate list size value N and the threshold value t are obtained. The process 900 continues to decision block 940 and determines whether the merge candidate list size value N is greater than the threshold value t. If the answer is yes, the process 900 continues to block 942, and the index m of the TMVP is determined. The index m of the TMVP may be set to an integer that is smaller than the merge candidate list size value N (or N−1 if the index begins at position 0). The process 900 then continues to block 944, and the TMVP is included in index position m in the merge candidate list. Including the TMVP can mean either inserting or adding the TMVP into the merge candidate list. Because of the insertion of the TMVP, the list entries below the index m are shifted down one position (each list entry at index position m and greater have their index position increased by one). If after shifting down, an entry is in a position greater than the list size N (or N−1 if the index begins at position 0), then that spatial MV candidate may not be included in the merge candidate list. The process 900 ends at block 946.

If at block 940, the answer is no, the process 900 continues to block 946 and ends. No reordering is performed in this case. Other types of motion vector candidates may be used as well, such as base layer motion vector candidates, base view or disparity motion vector candidates. They may be added to the list before TMVP.

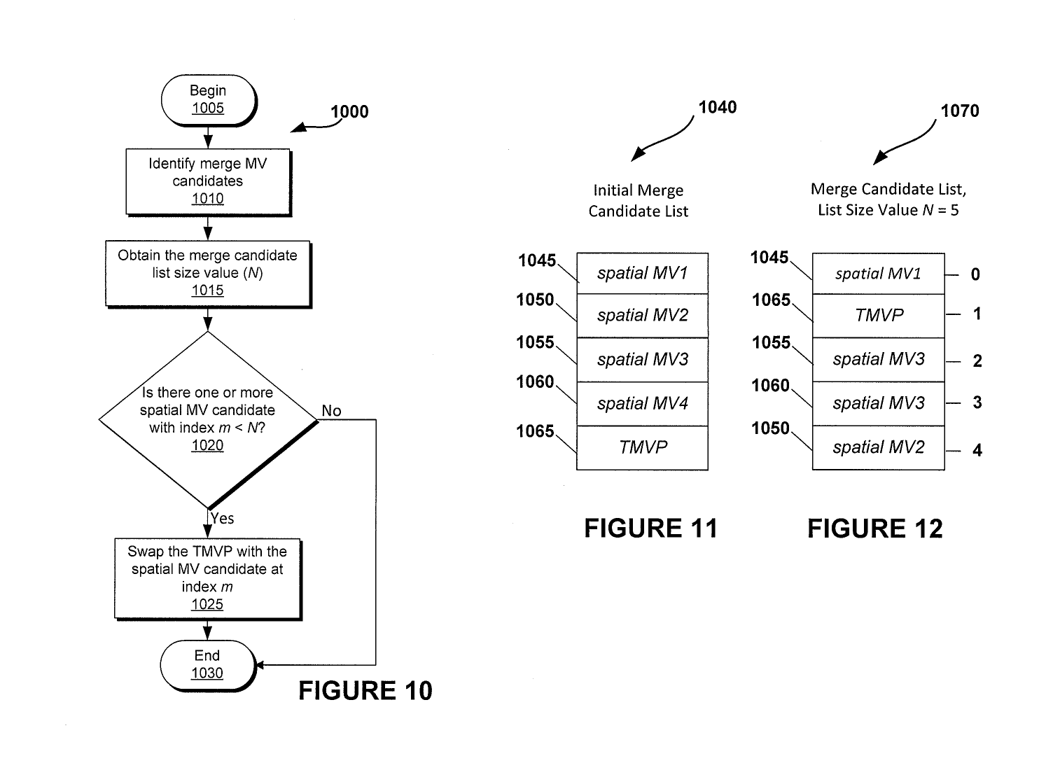

FIG. 10 is a flowchart that illustrates an embodiment of a process of reordering a merge motion vector candidate list by swapping the TMVP with a merge MV candidate. The process 1000 begins at block 1005. At block 1010, spatial MV candidates are identified. The process 1000 continues to block 1015, and obtains the merge candidate list size value (N). The process 1000 then continues to decision block 1020 and determines whether there is one or more spatial MV candidate with an index m that is less than the merge candidate list size value N if the index starts at 0 (or less than or equal to N if the index m begins at 1). If the answer to the question in decision block 1020 is yes, then the process 1000 continues to block 1025, and the TMVP is swapped with the spatial MV candidate at index m. The TMVP has an index m, and the swapped spatial MV candidate is moved to the original position of the TMVP. The process 1000 ends at block 1030.

However, if at decision block 1020 it is determined that there is no spatial MV candidate with an index m that is smaller than the merge candidate list size value N if the index starts at 0 (or less than or equal to N if the index starts at 1), then the process 1000 continues to block 1030, where the process 1000 ends without reordering the list. In some embodiments, other types of motion vector candidates may be used as well, such as base layer motion vector candidates, base view or disparity motion vector candidates. They may be added to the list before TMVP.

FIG. 11 is an illustrative example of an initial merge candidate list 1040 prior to reordering. In this example, the initial merge candidate list 1040 includes may include up to four spatial MV candidates 1045, 1050, 1055, 1060 and a TMVP 1065. The number of candidates added before TMVP may be subject to availability and pruning.

FIG. 12 is an illustrative example of an embodiment of a merge candidate list 1070 after reordering the initial merge candidate list 1040. In this example, the merge candidate list size value is 5 (N=5). Index values for the entries in the list 1070 start at 0 and end at 4. The TMVP 1065 in this example has been swapped with the spatial MV2 1050. After swapping, the index m of the TMVP 665 is m=1 (index m starts at 0 in this example), which means the TMVP 1065 is inserted in the second position in the merge candidate list 1070. Spatial MV1 1045 remains at the same position as in the initial merge candidate list 1040, with an index of 0. Because of the swapping of the TMVP 1065 with the spatial MV2 1050, spatial MV2 1050 is moved from its original second position (from index position 1) in the initial merge candidate list 1040 to the fourth position (to index position 3) in the merge candidate list 1070. Spatial MV3 1055 remains at its original position with an index of 2, as the third entry in the merge candidate list 1040. Spatial MV4 also remains at its original position with an index of 3, as the fourth entry in the merge candidate list 1040. In some embodiments, other types of motion vector candidates may be used as well, such as base layer motion vector candidates, base view or disparity motion vector candidates. They may be added to the list before TMVP.

In this example, because the merge candidate list size value N is 5, all the merge candidates and the TMVP can be included in the merge candidate list. In other embodiments, the size N may be smaller than 5. Therefore, after swapping the TMVP with a merge candidate with an index m that is smaller than the merge candidate size N, the TMVP will still be included in the merge candidate list. The merge candidate that swapped position with the TMVP may not be included in the merge candidate list if the swapped merge candidate would have an index m that is greater than the merge candidate list size value N (or N−1 if m starts at 0).

In various video standards (e.g., HEVC, etc.), the merge candidate list size value N or maximum number of candidates in the merge MV candidate list is signaled by the encoder 20 for receipt by the decoder 30 in the encoded bitstream, and the MV candidate list sizes are the same for all the PUs inside a CU. However, in some situations, the number of available candidates may be smaller, which may require generation of more artificial merge candidates to fill up the list of merge candidates.

According to the techniques of this disclosure, different merge candidate list sizes may be used for different PUs. For example, video encoder 20 may determine a list size of a first merge candidate list, wherein the first merge candidate list is associated with a first PU of a CU. The video encoder 20 may also determine the list size of a second merge candidate list, wherein the second merge candidate list is associated with a second PU of the CU.

The sizes of the merge candidate lists for each PU may also be signaled at PU, CU, LCU, groups of CU levels, and in SPS, PPS, and/or APS headers. The sizes may also be derived from coding context, such as neighboring blocks of a current block, or as offsets to the single maximum number of merge motion candidates signaled in the current HEVC Test Model (“HM”).

For example, in N×N mode, the maximum number of PUs in a CU may be four. Therefore, four list sizes, N₁, N₂, N₃, and N₄ may be provided for each of the four PUs, instead of signaling a single list size N for all PUs.

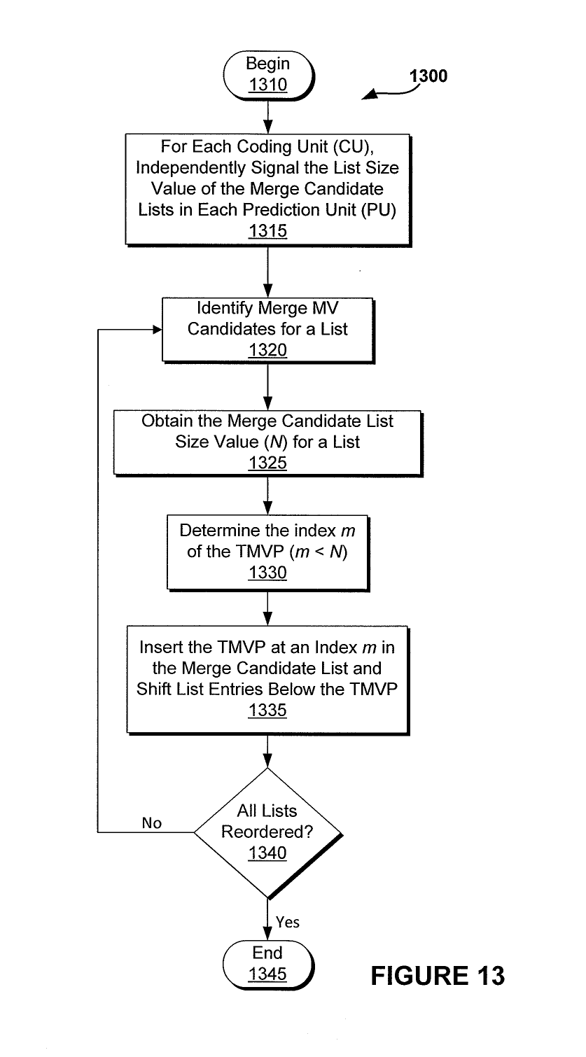

The four numbers N₁, N₂, N₃, and N₄ may be signaled in different forms. For example, the video encoder 20 may signal the list sizes independently. FIG. 13 is a flowchart that illustrates an example of reordering the merge candidate lists by independently signaling the sizes of the merge lists associated with each prediction unit (“PU”) in a coding unit (“CU”). The process 1300 starts at block 1310, and continues to block 1315. At block 1315, each PU in each CU may independently signal the merge candidate list size values of the merge candidate lists in the PU. For example, if there are four PUs within each CU, then PU₁ may signal the merge candidate list size value as N₁=5; PU₂ may signal the merge candidate list size value as N₂=2; PU₃ may signal the merge candidate list size value as N₃=3; and PU₄ may signal the merge candidate list size value as N₄=4. The process 1300 then continues to block 1320, where the spatial MV candidates are identified for a merge candidate list. The process 1300 then continues to block 1325, where the merge candidate list size value N of a merge candidate list is received. For example, if the merge candidate list is associated with PU₃, its merge candidate list size value may be signaled at PU₃ as N₃=3.

The process 1300 continues to block 1330, and determines the index m of the TMVP. In this example, the index m starts at 0, which indicates the first position in a merge candidate list, and continues to N−1, which indicates the last position in the merge candidate list. In other embodiments, the index may start at 1 and continue to N. At block 1330, the index m is set to an integer value (e.g., less than or equal to N−1 if the index starts at 0, or less than or equal to N if the index starts at 1) to make sure the TMVP (if available) is included in the merge candidate list. The process 1300 continues to block 1335, and the TMVP is inserted to the index m in the merge candidate list. All the entries below the TMVP at index m are shifted down (e.g., their index positions are each increased by one). The process 1300 continues to decision block 1340 to determine if all the lists are reordered. If the answer is no, then the process 1300 continues to block 1320, and repeats blocks 1320 through 1340. However, if the answer to the question at block 1340 is yes, then process 1300 ends.

Unlike the previous example of independently signaling the sizes of the merge candidate lists, the sizes may instead be derived from a formula. In some embodiments, the formula may be in the format that includes a common N. For example, the formula for the size of merge candidate lists may be Nᵢ=N−i. Other formulae may also be used. In this example, the values of Nᵢ are signaled in the four PUs in a CU inter-dependently. For example, according to the formula Nᵢ=N−i, PU₁ may signal the merge candidate list size value as N₁=4 (N=5, i=1). Similarly, PU₂ may signal the merge candidate list size value as N₂=3 (N=5, i=2); PU₃ signals the merge candidate list size value as N₃=2 (N=5, i=3); and PU₄ signals the merge candidate list size value as N₄=1 (N=5, i=4).

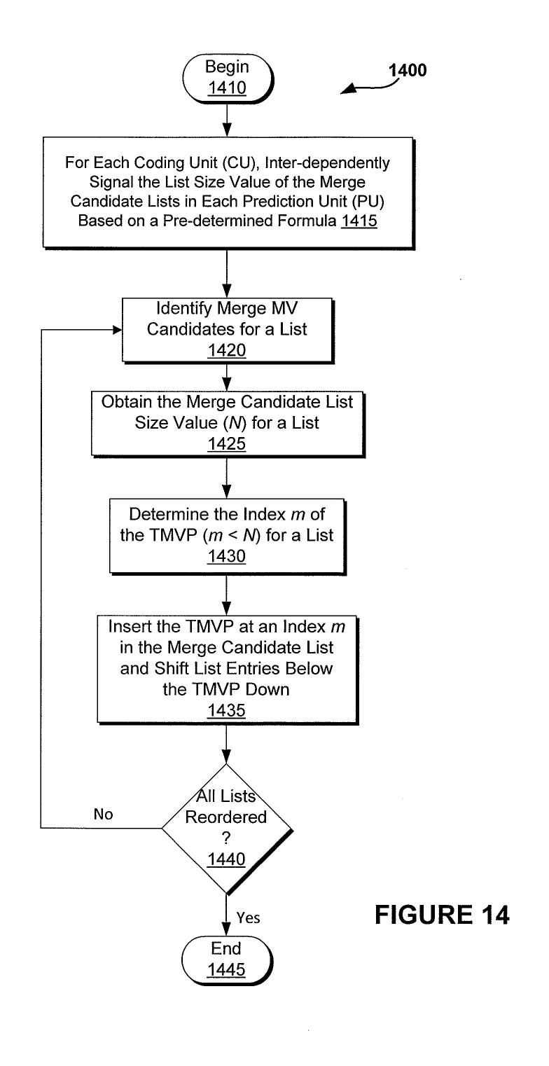

FIG. 14 is a flowchart that illustrates an embodiment of the process of reordering the merge candidate lists by inter-dependently signaling the sizes of the merge lists associated with each prediction unit (“PU”) in a coding unit (“CU”). The process 1400 starts at block 1410 and continues to block 1415. At block 1415, each PU in each CU may inter-dependently signal the merge candidate list size values of the merge candidate lists in the PU based on a formula, such as in the example given above, Nᵢ=N−i. Other formulae may also be used.

The process 1400 continues to block 1420, where the spatial MV candidates are identified for a merge candidate list. At block 1425, the merge candidate list size value N of a merge candidate list is received. For example, if the merge candidate list is associated with PU₃, its merge candidate list size value may be signaled at PU₃ as N₃=2.

The process 1400 continues to block 1430 and determines the index m of the TMVP. The index m starts at 0, which indicates the first position in a merge candidate list, and continues to N−1, which indicates the last position in the merge candidate list. In other embodiments, the index may start at 1 and continue to N. At block 1430, the index m is set to an integer value (e.g., less than or equal to N−1 if the index starts at 0, or less than or equal to N if the index starts at 1) to make sure the TMVP is included in the merge candidate list. The process 1400 continues to block 1435, and the TMVP is inserted to the index m in the merge candidate list. All the entries below the TMVP at index m are shifted down (e.g., their index positions are each increased by one). The process 1400 continues to decision block 1440 to determine if all the lists are reordered. If the answer is no, then the process 1400 continues to block 1420, and repeats blocks 1420 through 1440. However, if the answer to the question at block 1440 is yes, then the process 1400 ends at block 1445.

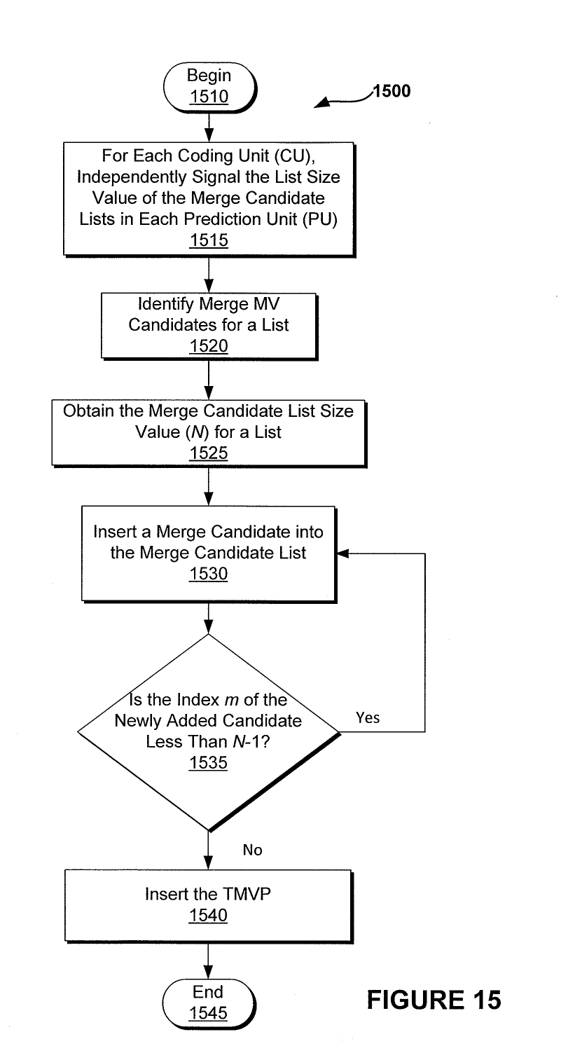

A slot may be reserved for the TMVP to make sure that it is included in the merge candidate list. FIG. 15 is a flowchart that illustrates an example of including the TMVP in the merge candidate list by checking each merge candidate's index and reserving a slot for the TMVP in the merge candidate list. The process 1500 starts at block 1510 and continues to block 1515, where each PU in each CU may independently signal the list size of the merge candidate lists in the PU.

The process 1500 continues to block 1520, where it identifies the one or more merge candidates for a merge candidate list. The process continues to block 1525, where it receives the merge candidate list size value N of a merge candidate list. For example, if the merge candidate list is associated with PU₂, its merge candidate list size value may be signaled at PU₂ as N₂=4.

The process 1500 continues to block 1530 and adds a merge candidate to the merge candidate list. The process 1500 then continues to decision block 1535 and determines whether the index m of the newly added candidate is less than N−1 (index m starts at 0. If index m starts at 1, the decision is whether the index m of the newly added candidate is less than N). If the answer is yes, the process 1500 continues to block 1530 and adds a merge candidate to the merge candidate list. If, however, the answer to the question in decision block 1535 is no (index m of the newly added candidate is not less than to N−1), then process 1500 continues to block 1540 and adds the TMVP to the merge candidate list. This makes sure that the TMVP has a spot in the merge candidate list. The process ends at 1545.

In some embodiments, instead of checking each newly added candidate as in decision block 1535, the determination of whether the index m of the newly added candidate is less than N−1 needs only be performed before adding the last few candidates. For example, in some cases, only the candidate at index N−2 (index m starts at 0, so the candidate at index N−2 is the N−1^{th} candidate added to the list). If index m starts at 1, the candidate at index N−1 is the N−1^{th} candidate added to the list) needs to be checked.

All the techniques described above may also be applied to reordering merge MVP candidate lists. In addition, some techniques and examples of this disclosure are described with respect to 16 samples arranged in four rows and four columns. It should be understood that all the techniques described herein can be applied to examples with blocks that contain more or fewer samples, in varying numbers of rows and columns.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A video coding device, comprising:
a memory configured to store an initial list of motion vector candidates having an initial list size value and a temporal motion vector predictor (TMVP); and
a processor in communication with said memory, the processor configured to:
obtain a merge candidate list size value;
identify one or more motion vector candidates from the initial list of motion vector candidates to include in a merge candidate list having a list size equal to the list size value, wherein the merge candidate list is a merge motion vector (MV) candidate list or a motion vector predictor (MVP) candidate list; and
generate the merge candidate list to include the TMVP, regardless of the list size.

2. The video coding device of claim 1, wherein the processor is further configured to generate the merge candidate list by including the TMVP in the merge candidate list at an index position smaller than the list size.

3. The video coding device of claim 2, wherein including the TMVP in the merge candidate list comprises one of adding and inserting the TMVP into the merge candidate list.

4. The video coding device of claim 2, wherein the index position is equal to one less than the list size.

5. The video coding device of claim 2, wherein the processor is further configured to determine the index position of the TMVP based on coding context information.

6. The video coding device of claim 2, wherein the index position of the TMVP is signaled at a prediction unit (PU) level, a coding unit (CU) level, a largest coding unit (LCU) level, a group of CU levels, or in a sequence parameter set (SPS), a picture parameter set (PPS), or an adaptation parameter set (APS) header.

7. The video coding device of claim 2, wherein the processor is further configured to insert the TMVP into the merge candidate list when the list size is greater than a predetermined threshold value.

8. The video coding device of claim 1, wherein the processor is further configured to generate the merge candidate list by swapping the TMVP with a merge candidate list entry having an index position smaller than the list size.

9. The video coding device of claim 8, wherein the index of the TMVP is equal to one less than the list size.

10. The video coding device of claim 1, wherein the processor is further configured to prune the initial list to remove duplicate list entries.

11. The video coding device of claim 1,
wherein the motion vector candidates and temporal motion vector predictor are associated with a first prediction unit of a coding unit,
wherein the memory is further configured to store additional motion vector candidates and a second temporal motion vector (second TMVP) associated with a second prediction unit of the coding unit, and
wherein the processor is further configured to:
obtain a second merge candidate list size value;
identify additional motion vector candidates to include in a second, merge candidate list having a second list size equal to the second merge candidate list size value; and
generate the second merge candidate list such that the second merge candidate list includes the second TMVP, regardless of the second list size,
wherein the second list size is different than the first list size.

12. The video coding device of claim 1, wherein the processor is further configured to:
add merge candidates into the merge candidate list if the index of the last added merge candidate is smaller than the list size minus one; and
add the TMVP into the merge candidate list.

13. The video coding device of claim 1, wherein the processor is further configured to generate a bitstream that comprises an encoded representation of video data, the bitstream encoded such that each merge candidate list in the bitstream includes a TMVP if a TMVP is available, regardless of the list size.

14. The video coding device of claim 1, wherein the processor is further configured to:
obtain a bitstream that comprises an encoded representation of video data, the bitstream encoded such that each merge candidate list in the bitstream includes a TMVP if a TMVP is available, regardless of the list size; and
decode the video data using the merge candidate list in the bitstream.

15. A method of video coding, comprising:
storing an initial list of motion vector candidates and a temporal motion vector predictor (TMVP);
obtaining a merge candidate list size value;
identifying one or more motion vector candidates from the initial list of motion vector candidates to include in a merge candidate list having a list size equal to the merge candidate list size value, wherein the merge candidate list is a merge motion vector (MV) candidate list or a motion vector predictor (MVP) candidate list; and
generating the merge candidate list to include the TMVP, regardless of the list size.

16. The method of claim 15, further comprising generating the merge candidate list by including the TMVP in the merge candidate list at an index position smaller than the list size.

17. The method of claim 16, wherein including the TMVP in the merge candidate list comprises one of adding and inserting the TMVP into the merge candidate list.

18. The method of claim 16, wherein the index position is equal to one less than the list size.

19. The method of claim 16, wherein the index position of the TMVP is determined based on coding context information.

20. The method of claim 16, wherein the index position of the TMVP is signaled at a prediction unit (PU) level, a coding unit (CU) level, a largest coding unit (LCU) level, a group of CU levels, or in a sequence parameter set (SPS), a picture parameter set (PPS), or an adaptation parameter set (APS) header.

21. The method of claim 16, further comprising inserting the TMVP into the merge candidate list when the list size is greater than a predetermined threshold value.

22. The method of claim 15, further comprising generating the merge candidate list by swapping the TMVP with a merge candidate list entry having an index position smaller than the list size.

23. The method of claim 22, wherein the index of the TMVP is equal to one less than the list size.

24. The method of claim 15, further comprising pruning the initial list to remove duplicate list entries.

25. The method of claim 15, wherein the motion vector candidates and temporal motion vector predictor are associated with a first prediction unit of a coding unit, the method further comprising:
storing additional motion vector candidates and a second temporal motion vector (second TMVP) associated with a second prediction unit of the coding unit;
obtaining a second merge candidate list size value;
identifying one or more of the additional motion vector candidates to include in a second merge candidate list having a second list size equal to the second merge candidate list size value; and
generating the second merge candidate list such that the second merge candidate list includes the second TMVP, regardless of the second list size,
wherein the second list size is different than the first list size.

26. The method of claim 15, wherein the method further comprising:
adding merge candidates into the merge candidate list if the index of the last added merge candidate is smaller than the list size minus one; and
adding the TMVP into the merge candidate list.

27. The method of claim 15, wherein the method further comprising generating a bitstream that comprises an encoded representation of video data, the bitstream encoded such that each merge candidate list in the bitstream includes a TMVP if a TMVP is available, regardless of the list size.

28. The method of claim 15, wherein the method further comprising:
obtaining a bitstream that comprises an encoded representation of video data, the bitstream encoded such that each merge candidate list in the bitstream includes a TMVP if a TMVP is available, regardless of the list size; and
decoding the video data using the merge candidate list in the bitstream.

29. A computer-readable storage medium having instructions stored thereon that when executed cause an apparatus to:
store an initial list of motion vector candidates having an initial list size value and a temporal motion vector predictor (TMVP);
obtain a merge candidate list size value;
identify one or more motion vector candidates from the initial list of motion vector candidates to include in a merge candidate list having a list size equal to the merge candidate list size value, wherein the merge candidate list is a merge motion vector (MV) candidate list or a motion vector predictor (MVP) candidate list; and
generate the merge candidate list to include the TMVP, regardless of the list size.

30. The computer readable storage medium of claim 29, further comprising instructions to generate the merge candidate list by including the TMVP in the merge candidate list at an index position smaller than the list size.

31. The computer readable storage medium of claim 30, wherein including the TMVP in the merge candidate list comprises one of adding and inserting the TMVP into the merge candidate list.

32. The computer readable storage medium of claim 30, wherein the index position is equal to one less than the list size.

33. The computer readable storage medium of claim 30, further comprising instructions to determine the index position of the TMVP based on coding context information.

34. The computer readable storage medium of claim 30, further comprising instructions to signal the index position of the TMVP at a prediction unit (PU) level, a coding unit (CU) level, a largest coding unit (LCU) level, a group of CU levels, or in a sequence parameter set (SPS), a picture parameter set (PPS), or an adaptation parameter set (APS) header.

35. The computer readable storage medium of claim 30, further comprising instructions to insert the TMVP into the merge candidate list when the list size is greater than a predetermined threshold value.

36. The computer readable medium of claim 29, further comprising instructions to generate the merge candidate by swapping the TMVP with a merge candidate list entry having an index position smaller than the list size.

37. The computer readable medium of claim 36, wherein the index of the TMVP is equal to one less than the list size.

38. The computer readable medium of claim 29, further comprising instructions to prune the initial list to remove duplicate list entries.

39. The computer readable medium of claim 29, wherein the motion vector candidates and temporal motion vector predictor are associated with a first prediction unit of a coding unit, further comprising instructions to:
store additional motion vector candidates and a second temporal motion vector (second TMVP) associated with a second prediction unit of the coding unit;
obtain a second merge candidate list size value;
identify one or more of the additional motion vector candidates to include in a second merge candidate list having a second list size equal to the second merge candidate list size value; and
generate the second merge candidate list such that the second merge candidate list includes the second TMVP, regardless of the second list size,
wherein the second list size is different than the first list size.

40. The computer readable medium of claim 29, further comprising instructions to:
add merge candidates into the merge candidate list if the index of the last added merge candidates is smaller than the list size minus one; and
add the TMVP into the merge candidate list.

41. The computer readable medium of claim 29, further comprising instructions to generate a bitstream that comprises an encoded representation of video data, the bitstream encoded such that each merge candidate list in the bitstream includes a TMVP if a TMVP is available, regardless of the list size.

42. The computer readable medium of claim 29 further comprising instructions to:
obtain a bitstream that comprises an encoded representation of video data, the bitstream encoded such that each merge candidate lists in the bitstream includes the TMVP if a TMVP is available, regardless of the list size; and
decode the video data using the merge candidate list in the bitstream.

43. A video coding device, comprising:
means for storing an initial list of motion vector candidates having an initial list size value and a temporal motion vector predictor (TMVP);
means for obtaining a merge candidate list size value;
means for identifying one or more motion vector candidates from the initial list of motion vector candidates to include in a merge candidate list having a list size equal to the merge candidate list size value, wherein the merge candidate list is a merge motion vector (MV) candidate list or a motion vector predictor (MVP) candidate list; and
means for generating the merge candidate list to include the TMVP, regardless of the list size.

44. The device of claim 43, further comprising means for generating the merge candidate list by including the TMVP into the merge candidate list at an index position smaller than the list size.

45. The device of claim 44, wherein including the TMVP in the merge candidate list comprises one of adding and inserting the TMVP into the merge candidate list.

46. The device of claim 44, wherein the index position is equal to one less than the list size.

47. The device of claim 44, wherein the index position of the TMVP is determined based on coding context information.

48. The device of claim 44, wherein the index position of the TMVP is signaled at a prediction unit (PU) level, a coding unit (CU) level, a largest coding unit (LCU) level, a group of CU levels, or in a sequence parameter set (SPS), a picture parameter set (PPS), or an adaptation parameter set (APS) header.

49. The device of claim 44, further comprising means for inserting the TMVP into the merge candidate list when the list size is greater than a predetermined threshold value.

50. The device of claim 43, further comprising generating the merge candidate list by swapping the TMVP with a merge candidate list entry having an index position smaller than the list size.

51. The device of claim 50, wherein the index of the TMVP is equal to one less than the list size.

52. The device of claim 43, further comprising means for pruning the initial list to remove duplicate list entries.

53. The device of claim 43, wherein the motion vector candidates and temporal motion vector predictor are associated with a first prediction unit of a coding unit, the device further comprising:
means storing additional motion vector candidates and a second temporal motion vector (second TMVP) associated with a second prediction unit of the coding unit;
means for obtaining a second merge candidate list size value;
means for identifying one or more of the additional motion vector candidates to include in a second merge candidate list having a second list size equal to the second merge candidate list size value; and
means for generating the second merge candidate list such that the second merge candidate list includes the second TMVP, regardless of the second list size,
wherein the second list size is different than the first list size.

54. The device of claim 43, further comprising means for:
adding merge candidates into the merge candidate list if the index of the last added merge candidate is smaller than the list size minus one; and
adding the TMVP into the merge candidate list.

55. The device of claim 43, further comprising means for generating a bitstream that comprises an encoded representation of video data, the bitstream encoded such that each merge candidate list in the bitstream includes a TMVP if a TMVP is available, regardless of the list size.

56. The device of claim 43, further comprising means for:
obtaining a bitstream that comprises an encoded representation of video data, the bitstream encoded such that each merge candidate list in the bitstream includes a TMVP if a TMVP is available, regardless of the list size; and
decoding the video data using the merge candidate list in the bitstream.
